(19) United States
(12) Patent Application Publication
(10) Pub. No.: US 2005/0224124 A1
(43) Pub. Date: Oct. 13, 2005

(54) Sheathed microduct system

(76) Inventors: Tim A. Grimsley, Knoxville, TN (US); R. David Corey, Louisville, TN (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/483,671

(22) PCT Filed: Jul. 11, 2001
(86) PCT No.: PCT/US01/21841

§ 371 Date: Nov. 15, 2004

(51) Int. Cl. F16L 55/00

(52) U.S. Cl. 138/108; 138/115

(57) ABSTRACT

A conduit system is described. The conduit system primarily includes at least one cable (203), such as but not limited to a power and/or communication cable, at least one microduct (202), and a sheath (201) or binder over the cable/microduct bundle holding them in abutting engagement with one another. The conduit system can be installed by itself or into a larger conventional conduit system. Additional cables can then be easily and inexpensively introduced into the microduct as the need arises, for example, during network expansion.

### FIELD OF THE INVENTION

The present invention relates generally to cable conduit systems, and more particularly to a sheathed microduct system including at least one microduct and at least one power and/or communications cable in a substantially abutting relationship, wherein the at least one microduct is adapted to receive an additional power and/or communications cable in order to provide present and/or future expansion capability to the system.

### BACKGROUND OF THE INVENTION

Presently, there is a large pre-existing network of conduits, typically comprised of either polyethylene or polyvinyl chloride (PVC), which contain various types of cables (e.g., power and communication) that enable an individual or business at one location to easily and freely communicate and exchange information over long distances with an individual or business at a remote location.

These conduit routes typically consist of either ducts of various sizes directly buried in the ground, or relatively smaller cross-sectional diameter conduits (sub-ducts) which have been pulled into relatively larger cross-sectional diameter ducts. Optionally, even smaller cross-sectional diameter ducts may then be introduced into these sub-ducts. These very small ducts are popularly known as microducts, and typically have a cross-sectional diameter of about 5 to about 13 millimeters. Additionally, in recent years aerial ducts have been deployed for this same purpose.

The communications industry (e.g., telephone) in the past has generally used a single communications cable inside of an existing conduit to carry voice, data, video, and other specialized information or circuitry from one point to another point. Once the single cable is installed in the duct or conduit, very little opportunity exists to expand the network should the need arise, which it typically does. Even if removal of the cable is physically possible, there is generally no way of re-routing the communications traffic on the existing cable to ensure that service is not interrupted during the removal process and installation of the new cable. It is generally not cost effective to remove the existing cable to expand the network, as once the cable is removed, it is generally not re-useable.

In the past, just one conduit would typically be buried in the ground. Once the conduit was utilized, the communications provider would then have to obtain the necessary construction permits and construct a new conduit route at a substantial cost.

Several methods have been attempted to add additional cables over an existing cable in the same conduit with very limited success. Typically, heat would build up and damage either the new cable being installed or in most cases damage the existing cable. These different methods also consisted of trying to blow a pull rope through the duct with the existing cable. The pull rope would generally get tangled around the existing cable and never appear at the access point. If the installer were able to get the pull rope through to the access point, there was no guarantee that he or she would be able to pull the actual pull rope through or get the cable installed without damaging either the new or existing cable. Some progress has been made in using air to blow in a second cable over the existing cable. In this manner there is less chance of damage, but generally the installation lengths are dramatically reduced, which would require either more splice points or more access points along the proposed route, leading to a different set of concerns.

The nature of the communications industry is such that many different network providers will be required to share a finite amount of pre-existing conduit space. Currently, there does not exist a very practical way of achieving this result.

Therefore, there exists a need for a conduit system that provides a method for allowing various cables to be independently received into and routed through their own discrete conduit so as to allow for the easy and inexpensive future expansion of a network without the difficulty and expense of installing additional conduits at a later time.

### SUMMARY OF THE INVENTION

In accordance with a first embodiment of the present invention, a conduit system is provided, comprising: (1) at least one cable; (2) at least one microduct, wherein at least a portion of an external surface of the microduct substantially abuts at least a portion of an external surface of the at least one cable, wherein the at least one microduct is adapted to receive at least one other cable; and (3) a continuous sheath substantially enveloping the external surfaces of the at least one cable and the at least one microduct.

In accordance with a second embodiment of the present invention, a conduit system is provided, comprising: (1) at least one cable; (2) at least one microduct, wherein at least a portion of an external surface of the microduct substantially abuts at least a portion of an external surface of the at least one cable, wherein the at least one microduct is adapted to receive at least one other cable; and (3) an elongated member wound around at least a portion of the external surfaces of the at least one cable and the at least one microduct.

In accordance with a third embodiment of the present invention, a method of forming a conduit system is provided, comprising: (1) providing at least one cable; (2) providing at least one microduct, wherein the at least one microduct is adapted to receive at least one other cable; (3) providing a continuous sheath; (4) bringing at least a portion of an external surface of the microduct and at least a portion of an external surface of the at least one cable into abutting engagement; and (5) substantially enveloping the external surfaces of the at least one cable and the at least one microduct with the sheath.

In accordance with a fourth embodiment of the present invention, a method of forming a conduit system is provided, comprising: (1) providing at least one cable; (2) providing at least one microduct, wherein the at least one microduct is adapted to receive at least one other cable; (3) providing an elongated member; (4) bringing at least a portion of an external surface of the microduct and at least a portion of an external surface of the at least one cable into abutting engagement; and (5) winding the member around at least a portion of the external surfaces of the at least one cable and the at least one microduct.

A more complete appreciation of the present invention and its scope can be obtained from the following detailed description of the invention, the drawings and the appended claims.

### BRIEF DESCRIPTION OF THE DRAWINGS

The present invention will become more fully understood from the detailed description and the accompanying drawings, wherein:

FIG. 1a illustrates a plan view of an illustrative system for producing an over-sheath product, in accordance with one embodiment of the present invention;

FIG. 1b illustrates a front elevational view of a cable/duct collector of the system depicted in FIG. 1a, in accordance with one embodiment of the present invention;

FIG. 2a illustrates a cross-sectional view of a system including a cable with microducts wrapped entirely around the cable and an over-sheath around the microducts, in accordance with one embodiment of the present invention;

FIG. 2b illustrates a perspective view of the same construction as depicted in FIG. 2a, in accordance with one embodiment of the present invention;

FIG. 3a illustrates a cross-sectional view of a system including a cable with two microducts together on one side of the cable and an over-sheath around the microducts, in accordance with one embodiment of the present invention;

FIG. 3b illustrates a perspective view of the same construction as depicted in FIG. 3a, in accordance with one embodiment of the present invention;

FIG. 4a illustrates a cross-sectional view of a system including a cable with two microducts on opposing sides of the cable and an over-sheath around the microducts, in accordance with one embodiment of the present invention;

FIG. 4b illustrates a perspective view of the same construction as depicted in FIG. 4a, in accordance with one embodiment of the present invention;

FIG. 5a illustrates a cross-sectional view of a system including a cable with microducts surrounding roughly 50% of the cable and an over-sheath around the microducts, in accordance with one embodiment of the present invention; FIG. 5b illustrates a perspective view of the same construction as depicted in FIG. 5a, in accordance with one embodiment of the present invention;

FIG. 6a illustrates a cross-sectional view of a system including a cable with microducts wrapped entirely around the cable with a binder tape or string, and a second outer layer of microducts wrapping around the entire first inner layer and an over-sheath around the outer layer of microducts, in accordance with one embodiment of the present invention;

FIG. 6b illustrates a perspective view of the same construction as depicted in FIG. 6a, in accordance with one embodiment of the present invention;

FIG. 7a illustrates a cross-sectional view of a system including a cable with microducts wrapped entirely around the cable with a binder string or tape around the microducts holding the bundle together, in accordance with an alternative embodiment of the present invention;

FIG. 7b illustrates a perspective view of the same construction as depicted in FIG. 7a, in accordance with an alternative embodiment of the present invention;

FIG. 8a illustrates a cross-sectional view of a system including a cable with two microducts together on one side of the cable with a binder string or tape around the microducts holding the bundle together, in accordance with an alternative embodiment of the present invention;

FIG. 8b illustrates a perspective view of the same construction as depicted in FIG. 8a, in accordance with an alternative embodiment of the present invention;

FIG. 9a illustrates a cross-sectional view of a system including a cable with two microducts on opposing sides of the cable with a binder string or tape around the microducts holding the bundle together, in accordance with an alternative embodiment of the present invention;

FIG. 9b illustrates a perspective view of the same construction as depicted in FIG. 9a, in accordance with an alternative embodiment of the present invention; FIG. 10a illustrates a cross-sectional view of a system including a cable with microducts surrounding roughly 50% of the cable with a binder string or tape around the microducts holding the bundle together, in accordance with an alternative embodiment of the present invention;

FIG. 10b illustrates a perspective view of the same construction as depicted in FIG. 10a, in accordance with an alternative embodiment of the present invention;

FIG. 11a illustrates a cross-sectional view of a system including a cable with microducts wrapped entirely around the cable with a binder tape or binder string, and a second outer layer of microducts wrapping around the entire first inner layer with a binder tape or string around the second outer layer of microducts holding the entire bundle together, in accordance with an alternative embodiment of the present invention; and

FIG. 11b illustrates a perspective view of the same construction as depicted in FIG. 11a, in accordance with an alternative embodiment of the present invention.

The same reference numerals refer to the same parts throughout the various Figures.

### DETAILED DESCRIPTION OF THE INVENTION

As was previously noted, once a cable is installed in a duct or conduit, whether it be a conventional diameter duct or a microduct, there is very little opportunity to add additional communications cables as the network would need to grow. By the term “cable,” as that term is used herein, it is meant any type of power cable and/or communications cable. By the term “power cable,” as that term is used herein, it is meant any type of device that can transmit any form of electrical power. By the term “communications cable,” as that term is used herein, it is meant any type of device that can transmit any form of information, whether it be voice, data, images, and the like. By the term “microduct,” as that term is used herein, it is meant any relatively small cross-sectional diameter duct, tube, or conduit suitable for receiving a cable or similar device.

Although the present invention is directed primarily to a description of use in connection with communications cables, it should be appreciated that the present invention can be practiced with power cables, as well.

By way of a non-limiting example, new fiber optic cables are being introduced every few years and bandwidth requirements increase where additional fibers are required. With a fiber optic cable already in the duct, little opportunity exists to utilize the latest fiber technology or meet bandwidth requirements with additional fibers.

The present invention overcomes the deficiencies of conventional conduit systems, by enclosing microducts (i.e., relatively small cross-sectional diameter conduits) and one or more communication(s) and/or power cable(s) within a polyethylene sheath which will allow for longer installations as all the individual components are bundled into a single unit.

An alternative embodiment of the present invention provides taking the individual components and using a binding machine to place a binder string or binder tape around the components to make them into a single unit.

Regardless of the methodology used to assemble the individual components into a single unit, installation of the sheath or the binder can either be done at the factory or at the job site.

This bundle of microducts and power and/or communications cable can then be installed inside of a larger (i.e., conventional) duct generally made of polyethylene, PVC, and the like. During the installation process, the complete bundle can be pulled or pushed out at an access point along the proposed route and reinserted which will assist in making a longer installation. By using this method of bundling, i.e., the microducts and power and/or communications cable as a single unit, it allows for future growth within a network which would not normally exist if only one power and/or communications cable were installed by itself. By better utilizing this conduit space, network expansion can be made cost effective and bandwidth can be quickly re-routed in the desired directions while utilizing the limited space of an already occupied conduit. By installing microducts with a standard sheathed communications cable, additional communication cables can be installed within the microducts themselves, allowing for each cable or communications provider to have separation from one another, i.e., virtually having their own independent networks.

An additional option is during the over-sheath process to co-extrude an outer layer of a friction-reducing (e.g., lubricous) compound on the outside of the over-sheath, which would ease the installation of the over-sheathed bundle. This outer layer would then become part of the over-sheath and could not be removed by itself.

By utilizing the optional friction reducing compound co-extruded on the outside of the over sheath, one will be able to achieve longer installation lengths, as the friction for the bundle will be reduced. The lubricous compound is an alternative to using a wet lubricant to reduce friction during the installation, although a wet lubricant can also be used at the same time if desired. By increasing the thickness of the over-sheath option, this product can be directly buried in the ground if no existing conduits were available.

By utilizing the present invention, one will have the power and/or communications cable to meet current needs as well as having a pathway (microducts) to install future cables as new fiber types become available or additional fibers are required to meet bandwidth requirements. Also with the present invention, one can install the cables as required, rather than requiring all cables be installed at one time. This will substantially reduce the up-front cost of building or upgrading a network.

The present invention represents a much lower cost alternative to building an entire new duct structure or burying a new communications cable between points. In many cases, eight or more cables can be installed in one conduit, versus using the traditional method, where only one cable could be installed in most cases. By using either the over-sheath method or the binder method, one has the option as to how many microducts can be attached, allowing customization of the installation to meet virtually every conceivable need.

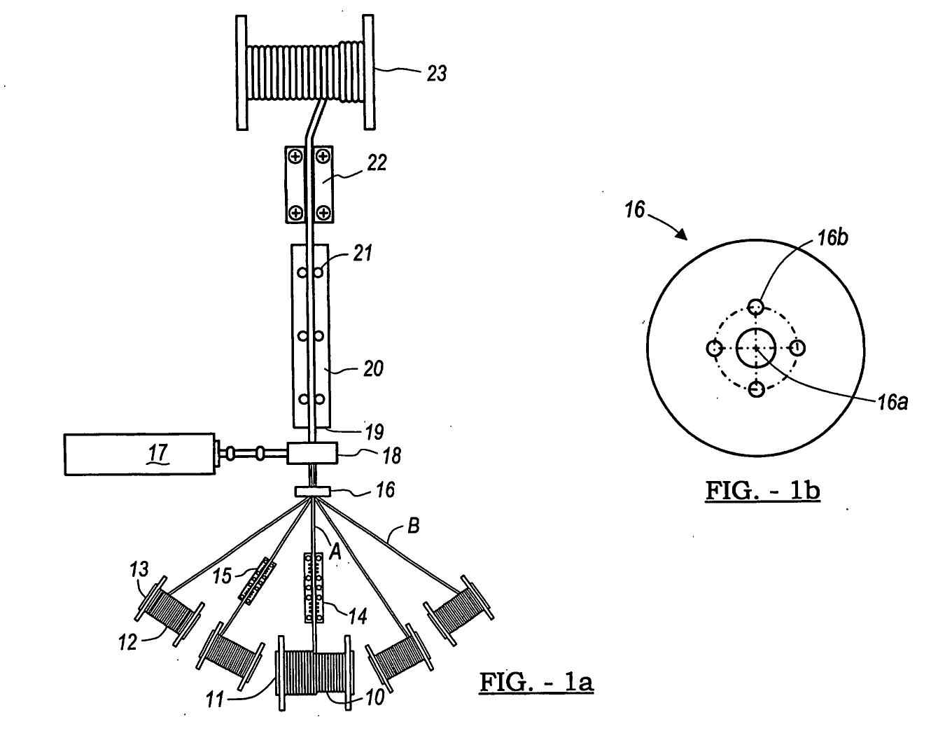

A non-limiting example of a description of the over-sheath process is made with reference generally to FIGS. 1a-1b.

The production of the over-sheath product is mainly a two-stage process. The first stage involves the production or procurement of microducts B, either internally longitudinally ribbed, internally and externally longitudinally ribbed, or smooth walled, varying in outside cross-sectional diameter from about 5 millimeters to about 13 millimeters. It should be appreciated that the present invention can be practiced with microducts which are either smaller than or larger than the previously described cross-sectional diameter.

The second stage involves sheathing a bundle of the microducts B around a cable A (in this case a communications cable is shown, although power cable can also be used alone or in combination with a communications cable), with a layer of polyethylene or other suitable plastic material. The sheath, over-sheath, or sheathing, as those terms are used synonymously, is preferably a hollow, continuous material having a substantially round cross-sectional diameter that is capable of substantially tightly receiving the bundled components. In stage one, the microducts B are either optionally manufactured by conventional extrusion processes or purchased from a vendor. The microducts B can be comprised of any suitable material, such as but not limited to polyethylene, and preferably high density polyethylene (HDPE) with an optional inner and/or outer layer of lubricous material applied thereto (e.g., SILICORE™, Dura-Line Corporation, Knoxyille, Tenn.).

In stage two, the process of sheathing a bundle of the microducts B around a power and/or communications cable A first starts with an illustrative proper setup as specifically shown in FIG. 1a.

The cable reel 10 is preferably properly secured on its payoff stand 11 and is placed about 25 feet behind the sheathing vacuum die 18. The microduct reels 12 also need to be preferably properly secured on their respective payoff stands 13 and placed symmetrically on opposite sides of each other. Roller stand 14 should then be placed between the cable reel 10 and the cable/duct collector 16. Similarly, roller stands 15 should also be placed between the microduct reels 12 and the cable/duct collector 16. A collector box 19, preferably adapted to absorb surface moisture and to cool the over-sheath, is fixed to the entrance of the first cooling tank 20. Rollers 21 of proper size are placed inside the 6 feet long cooling tank 20 at regular intervals. The water in the cooling tank is preferably maintained at around 53° F.

To begin production, a starter duct is first pulled through the production line, with its upstream end about 3 inches from the vacuum die 18 and the downstream end about 3 feet beyond the end of the puller 22. The puller belts are then closed with sufficient belt pressure. The extruder 17, after having reached the desired temperatures on its barrels and dies, is then started. The plastic that comes out of the die 18 is wrapped around the starter duct and the puller 22 is started. The starter duct, with the sheathing attached to its upstream end, is pulled through the cooling tank 20 and through the puller 22. This step facilitates the startup process, and additionally, it also eliminates the possibility of any moisture under the sheathing when the product is made.

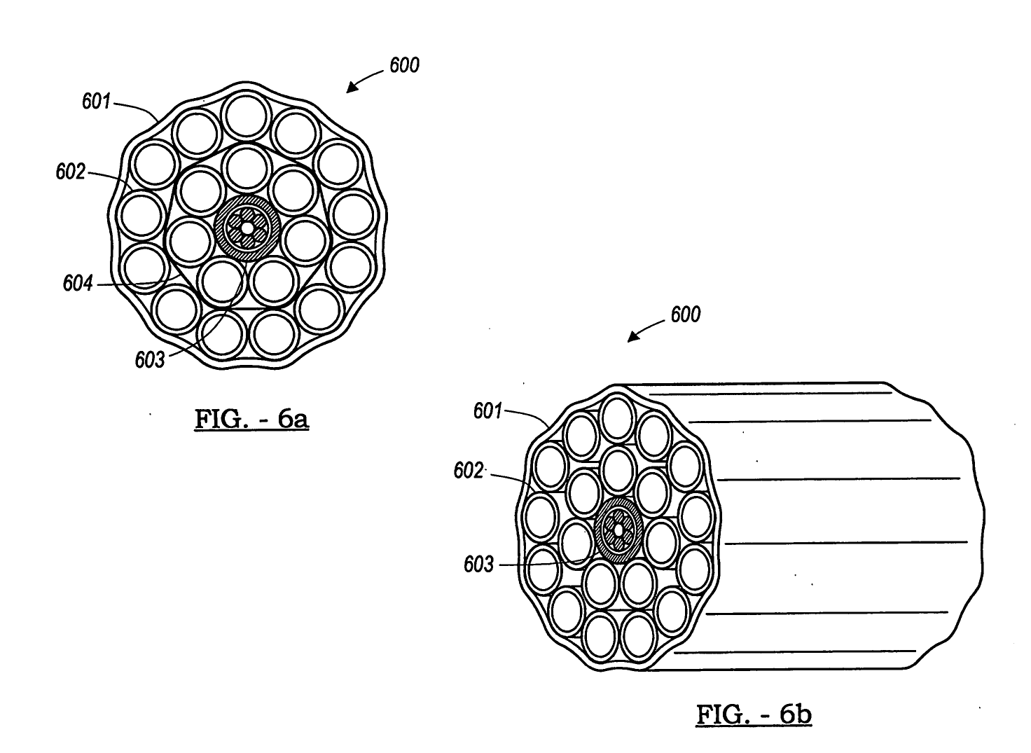

Soon after, the cable A and the microducts B are pulled through their respective sets of rollers (14 for the cable A, and 15 for the microducts B). This aids in straightening of the microducts B and the cable A. The microducts B are then passed through their respective holes 16b of the cable/duct collector 16, as shown in FIG. 6b. Similarly, the cable A is also pulled through the central hole 16a of the cable/duct collector 16. The microducts B and the cable A are then bundled (i.e., preferably brought into abutting engagement) and inserted through the vacuum die 18 and through the sheathing. The sheathing material may be comprised of any number of suitable materials, such as but not limited to polyethylene (PE), or any other type of plastic or plastic-like material, preferably having fire retardant properties.

Due to the design of the vacuum die 18, the plastic coming out of the die shrink wraps around the microducts A bundle, with the cable in the center. It is then pulled through the cooling tank 20 and finally through the belt puller 22. As it passes through the cooling tank 20, the sheathing hardens, but remains somewhat flexible.

Fine-tuning can then be carried out between the speed of the extruder 17 and that of the puller 22 to get the necessary thickness of sheathing. Once the correct thickness of sheathing is attained, the product is reeled onto a reel 23 or coiled for shipment.

Care needs to be taken in providing the right amount of belt pressure in the puller 22 and correct amount of vacuum in the vacuum die 18 to avoid over-tightening of the sheathing, which may cause excessive ovality of the microducts B.

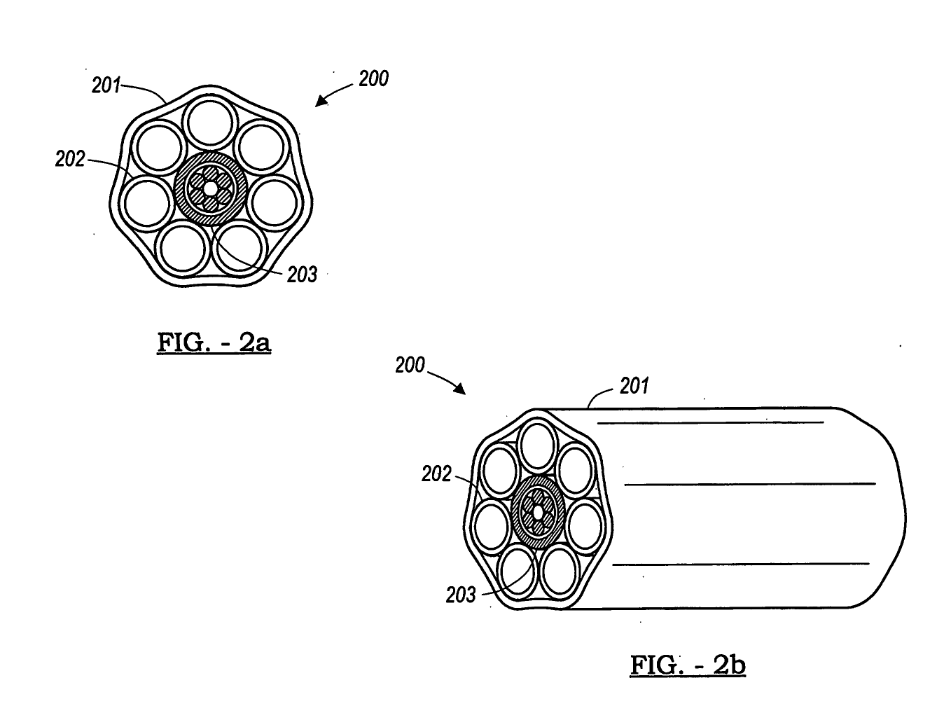

Accordingly, it is possible to combine any number of possible cable/microduct configurations that are desired. By way of non-limiting examples, reference is made generally to FIGS. 2a-6b.

Referring to FIGS. 2a-2b, there is shown a system 200 including a cable 203 with microducts 202 wrapped entirely around the cable and an over-sheath 201 around the microducts 202. Note that at least a portion of the external surfaces of the microducts 202 are in abutting engagement with the cable 203.

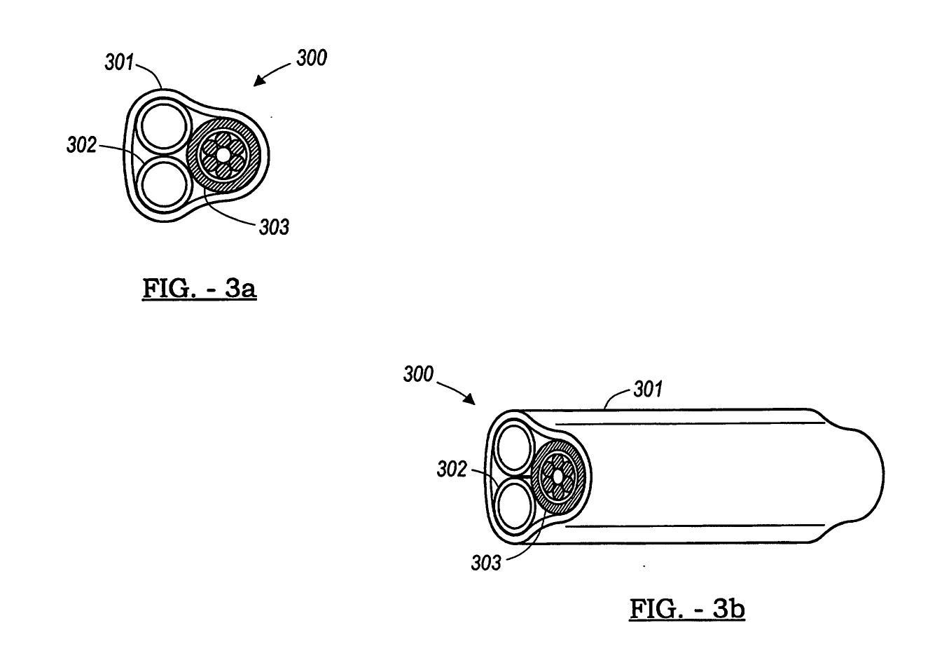

Referring to FIGS. 3a-3b, there is shown a system 300 including a cable 303 with two microducts 302 together on one side of the cable and an over-sheath 301 around the microducts 302. Note that at least a portion of the external surfaces of the microducts 302 are in abutting engagement with the cable 303.

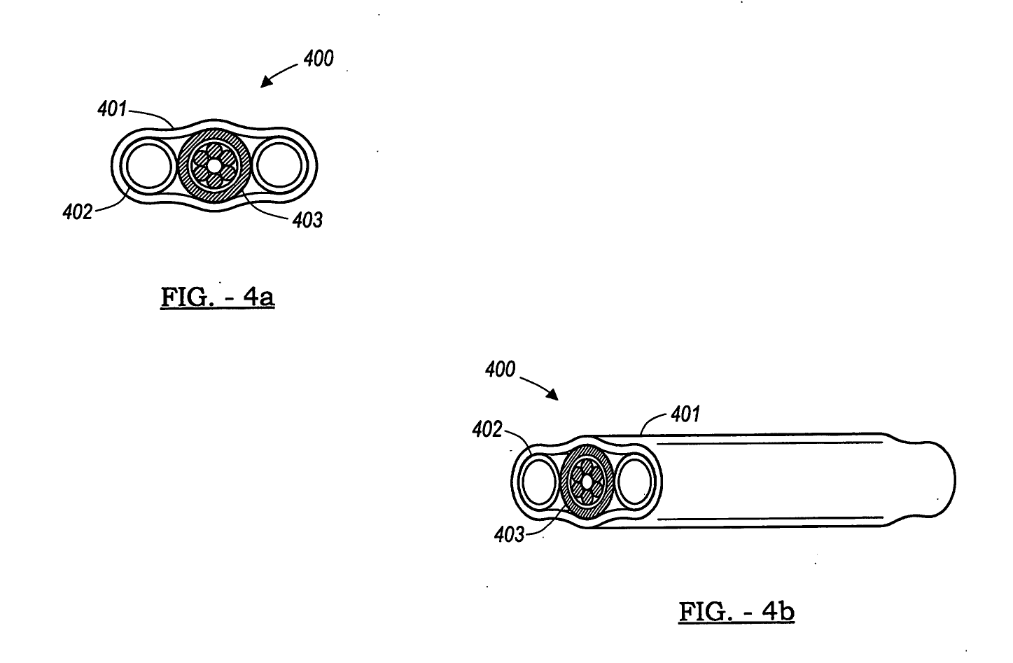

Referring to FIGS. 4a-4b, there is shown a system 400 including a cable 403 with two microducts 402 on opposing sides of the cable and an over-sheath 401 around the microducts 402. Note that at least a portion of the external surfaces of the microducts 402 are in abutting engagement with the cable 403.

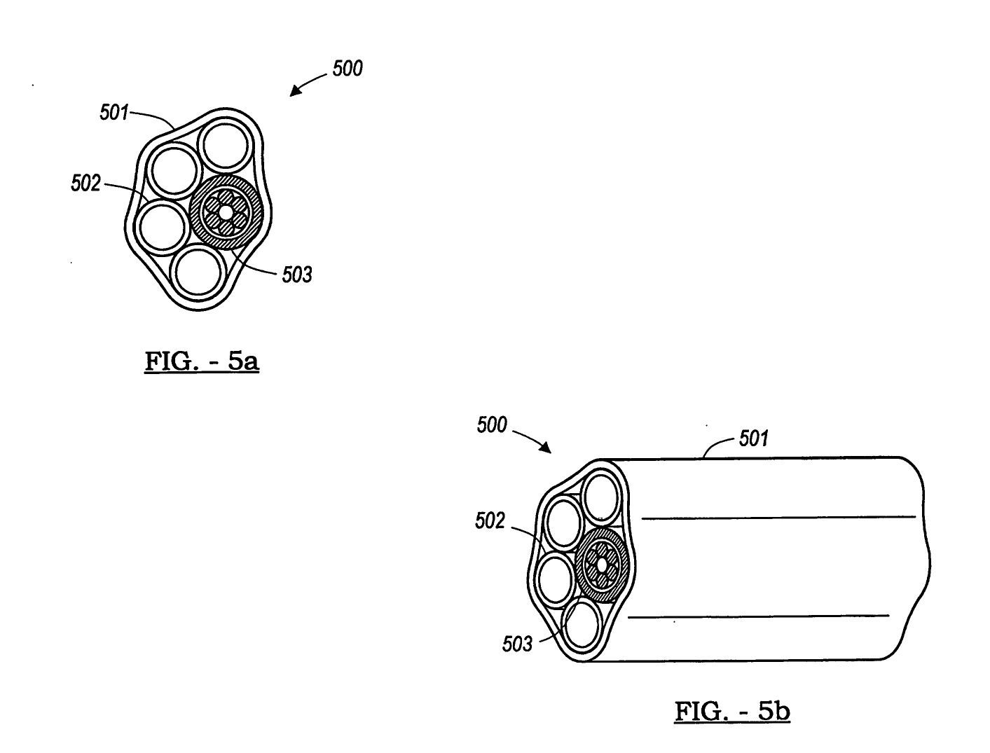

Referring to FIGS. 5a-5b, there is shown a system 500 including a cable 503 with microducts 502 surrounding roughly 50% of the cable and an over-sheath 501 around the microducts 502. Note that at least a portion of the external surfaces of the microducts 502 are in abutting engagement with the cable 503.

Referring to FIGS. 6a-6b, there is shown a system 600 including a cable 603 with microducts 602 wrapped entirely around the cable 603 with a binder tape or string 604, and a second outer layer of microducts 602 wrapping around the entire first inner layer and an over-sheath 601 around the outer layer of microducts 602. The methodology describing the use of binder tape or string 604 will be described herein.

A non-limiting example of a description of the binder process is set forth below. The binder tape or binder string, as those terms are used synonymously, is preferably a substantially elongated, solid, continuous length of material that is capable of being tightly wound around the bundled components. As opposed to the previously described sheathing material, the binder tape or string is said to be a discontinuous sheath in that, once applied, it does not cover the entire external surfaces of the bundled components, but rather only a limited portion thereof.

Initially, the binder process assumes that the production/procurement of the microducts and the power and/or communications cable is already complete.

The reels of microducts and cable are staged just behind the starting point of the installation. The reels are placed in such a fashion so as to allow for free movement of the reels and the product as it is pulled off the reels. The product should not be allowed to drag across the ground as collecting dirt and twigs will create a problem during an on-site installation, for example.

Once the microducts and cable are pulled off either their individual or combined reels, the product will be pulled through a collector where the microducts will be placed next to the cable in a configuration which best suits the installation requirements.

After the microducts and cable are pulled through the collector, it immediately goes through a binder machine which places either a binder string or binder tape around the entire bundle. The string or tape will be tight enough to hold the bundle together, but preferably not tight enough to deform the microducts. The binder pitch (i.e., the distance between binders) will vary depending on the configuration of the finished product. The larger the finished bundle, the tighter the binder pitch should preferably be.

Once the bundle has been completed, the entire unit is preferably fed into an air jetting machine for the installation into a duct typically comprised of polyethylene or PVC. A pulling grip could also be attached to the bundle, and the entire unit would be pulled into the duct, or the bundled unit could be buried directly into the ground or attached aerially in some fashion.

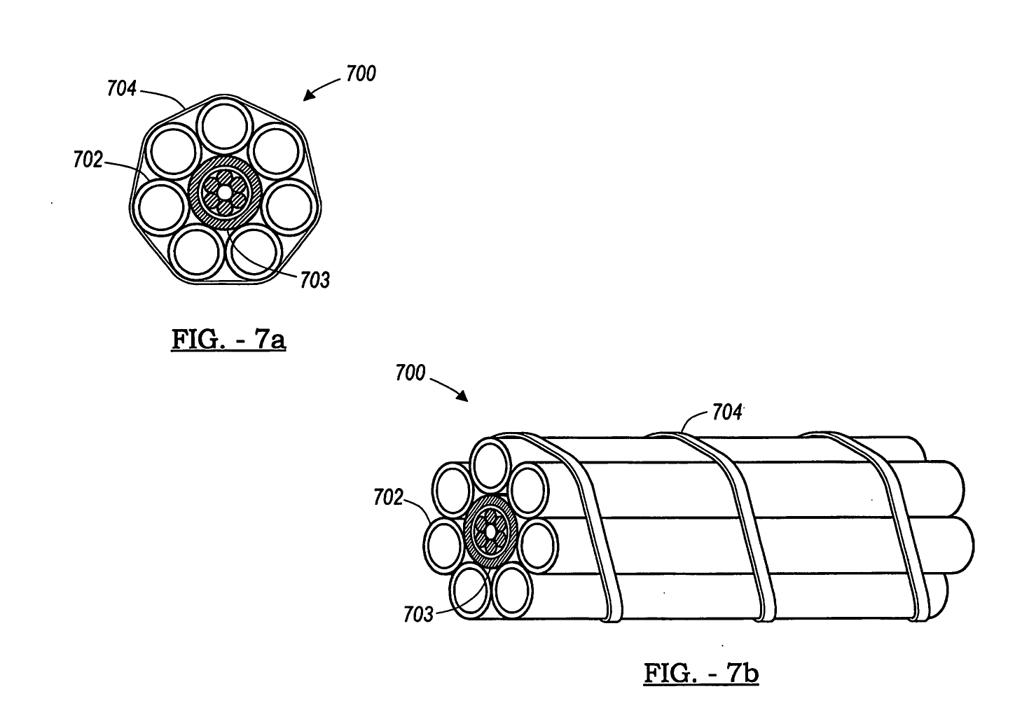

Accordingly, as with the previously described embodiment, it is possible to combine any number of possible cable/microduct configurations that are desired. By way of non-limiting examples, reference is made generally to FIGS. 7a-11b.

Referring to FIGS. 7a-7b, there is shown a system 700 including a cable 703 with microducts 702 wrapped entirely around the cable 703 with a binder string or tape 704 around the microducts 702 holding the bundle together. Note that at least a portion of the external surfaces of the microducts 702 are in abutting engagement with the cable 703.

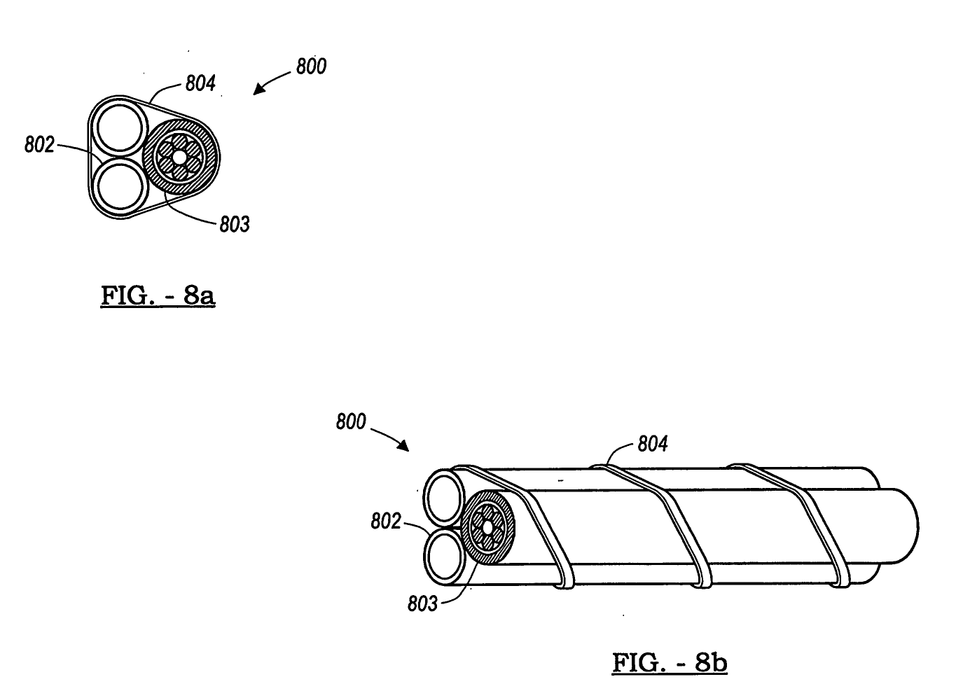

Referring to FIGS. 8a-8b, there is shown a system 800 including a cable 803 with two microducts 802 together on one side of the cable 803 with a binder string or tape 804 around the microducts 802 holding the bundle together. Note that at least a portion of the external surfaces of the microducts 802 are in abutting engagement with the cable 803.

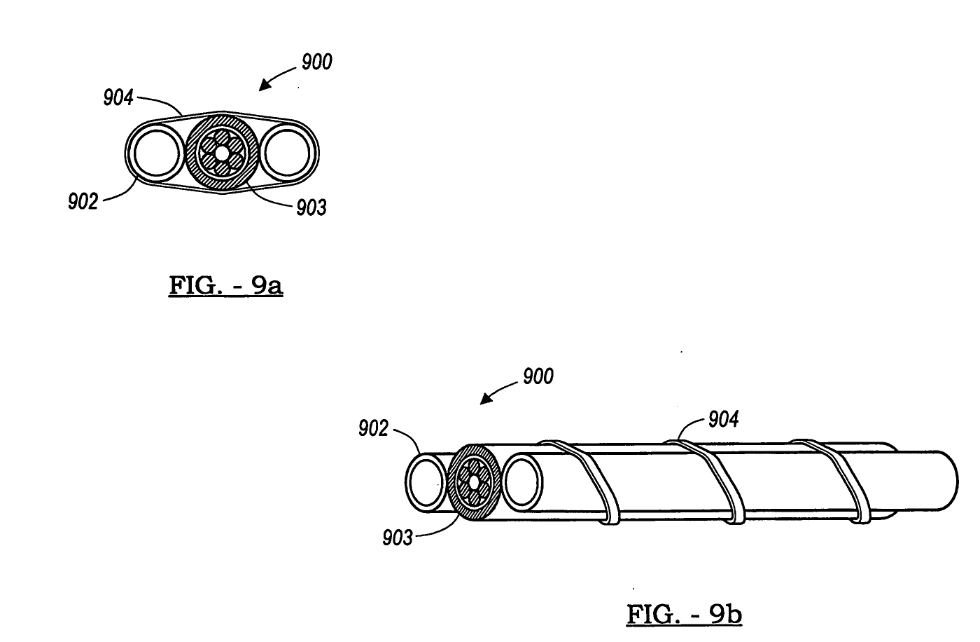

Referring to FIGS. 9a-9b, there is shown a system 900 including a cable 903 with two microducts 902 on opposing sides of the cable with a binder string or tape 904 around the microducts 902 holding the bundle together. Note that at least a portion of the external surfaces of the microducts 902 are in abutting engagement with the cable 903.

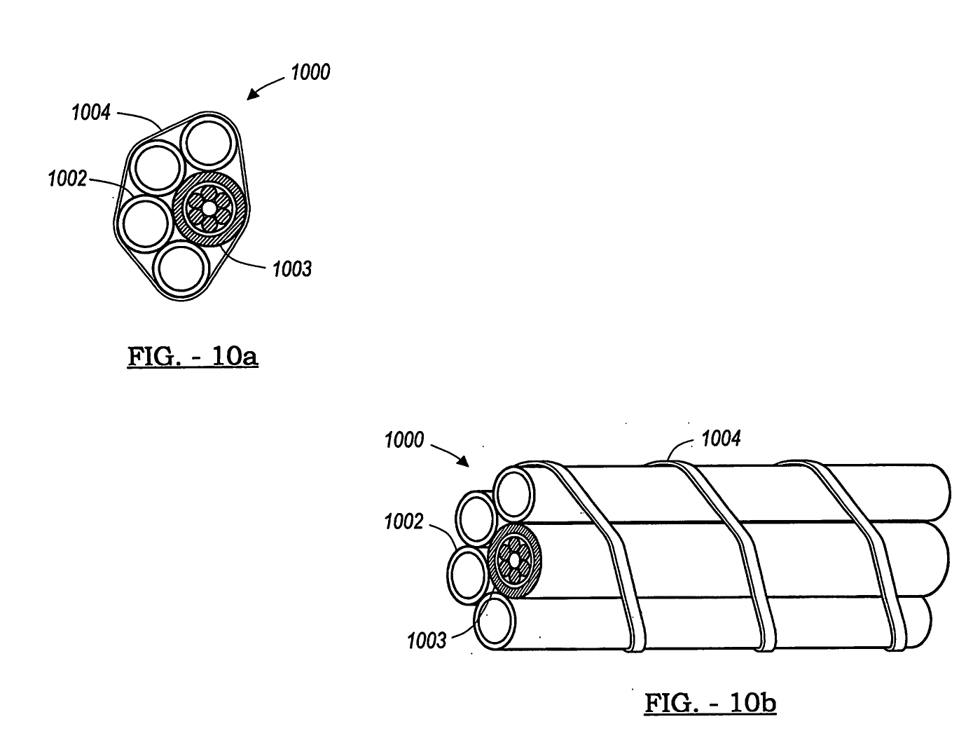

Referring to FIGS. 10a-10b, there is shown a system 1000 including a cable 1003 with microducts 1002 surrounding roughly 50% of the cable with a binder string or tape 1004 around the microducts 1002 holding the bundle together. Note that at least a portion of the external surfaces of the microducts 1002 are in abutting engagement with the cable 1003.

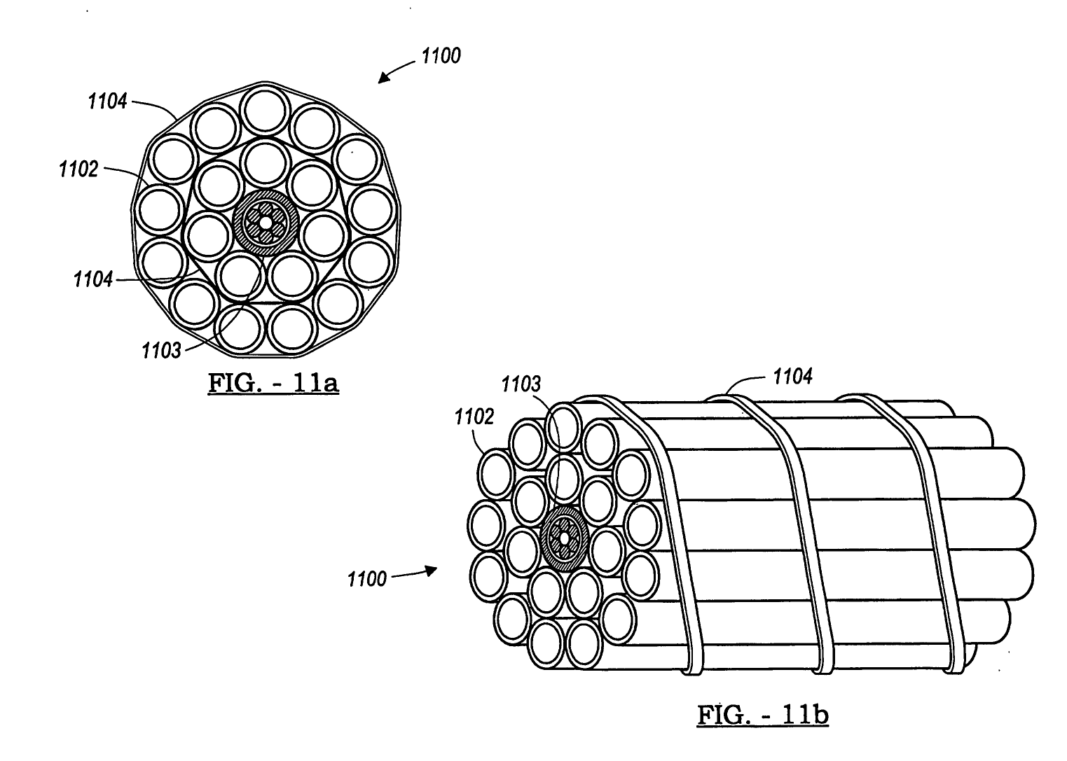

Referring to FIGS. 11a-11b, there is shown a system 1100 including a cable 1103 with microducts 1102 wrapped entirely around the cable with a binder tape or string 1104, and a second outer layer of microducts 1102 wrapping around the entire first inner layer with a binder tape or string 1104 around the second outer layer of microducts 1102 holding the entire bundle together. Note that at least a portion of the external surfaces of the microducts 1102 are in abutting engagement with the cable 1103.

The foregoing description is considered illustrative only of the principles of the invention. Furthermore, because numerous modifications and changes will readily occur to those skilled in the art, it is not desired to limit the invention to the exact construction and process shown as described above. Accordingly, all suitable modifications and equivalents that may be resorted to that fall within the scope of the invention as defined by the claims that follow.

1. A conduit system, comprising:
at least one cable;
at least one microduct, wherein at least a portion of an external surface of the microduct substantially abuts at least a portion of an external surface of the at least one cable, wherein the at least one microduct is adapted to receive at least one other cable; and
a continuous sheath substantially enveloping the external surfaces of the at least one cable and the at least one microduct.

2. The invention according to claim 1, wherein the cable is selected from the group consisting of communications cable, power cable, and combinations thereof.

3. The invention according to claim 1, wherein the at least one microduct has a cross-sectional diameter in the range of about 5 to about 13 millimeters.

4. The invention according to claim 1, wherein the at least one microduct is comprised of polyethylene.

5. The invention according to claim 1, wherein the at least one microduct is comprised of high density polyethylene.

6. The invention according to claim 1, wherein the sheath is comprised of polyethylene.

7. The invention according to claim 1, further comprising a lubricous material applied to at least a portion of an external surface of the sheath.

8. The invention according to claim 1, wherein there are at least two microducts, wherein at least a portion of an external surface of the at least two microducts substantially abut at least a portion of an external surface of the at least one cable.

9. The invention according to claim 8, wherein the external surface of one of the at least two microducts substantially abuts the external surface of the other one of the at least two microducts.

10. The invention according to claim 8, wherein the external surface of one of the at least two microducts does not abut the external surface of the other one of the at least two microducts.

11. The invention according to claim 1, wherein there are a plurality of microducts, wherein at least a portion of an external surface of plurality of microducts substantially abut at least a portion of an external surface of the at least one cable.

12. The invention according to claim 11, wherein the external surface of one of the plurality of microducts substantially abuts the external surface of at least one other of the plurality of microducts.

13. A conduit system, comprising:
at least one cable;
at least one microduct, wherein at least a portion of an external surface of the microduct substantially abuts at least a portion of an external surface of the at least one cable, wherein the at least one microduct is adapted to receive at least one other cable; and
an elongated member wound around at least a portion of the external surfaces of the at least one cable and the at least one microduct.

14. The invention according to claim 13, wherein the cable is selected from the group consisting of communications cable, power cable, and combinations thereof.

15. The invention according to claim 13, wherein the at least one microduct has a cross-sectional diameter in the range of about 5 to about 13 millimeters.

16. The invention according to claim 13, wherein the at least one microduct is comprised of polyethylene.

17. The invention according to claim 13, wherein the at least one microduct is comprised of high density polyethylene.

18. The invention according to claim 13, wherein the member is comprised of polyethylene.

19. The invention according to claim 13, further comprising a lubricous material applied to at least a portion of an external surface of the member.

20. The invention according to claim 13, wherein there are at least two microducts, wherein at least a portion of an external surface of the at least two microducts substantially abut at least a portion of an external surface of the at least one cable.

21. The invention according to claim 20, wherein the external surface of one of the at least two microducts substantially abuts the external surface of the other one of the at least two microducts.

22. The invention according to claim 20, wherein the external surface of one of the at least two microducts does not abut the external surface of the other one of the at least two microducts.

23. The invention according to claim 13, wherein there are a plurality of microducts, wherein at least a portion of an external surface of plurality of microducts substantially abut at least a portion of an external surface of the at least one cable.

24. The invention according to claim 23, wherein the external surface of one of the plurality of microducts substantially abuts the external surface of at least one other of the plurality of microducts.

25. A method of forming a conduit system, comprising:
providing at least one cable;
providing at least one microduct, wherein the at least one microduct is adapted to receive at least one other cable;
providing a continuous sheath;
bringing at least a portion of an external surface of the microduct and at least a portion of an external surface of the at least one cable into abutting engagement; and
substantially enveloping the external surfaces of the at least one cable and the at least one microduct with the sheath.

26. The invention according to claim 25, wherein the cable is selected from the group consisting of communications cable, power cable, and combinations thereof.

27. The invention according to claim 25, wherein the at least one microduct has a cross-sectional diameter in the range of about 5 to about 13 millimeters.

28. The invention according to claim 25, wherein the at least one microduct is comprised of polyethylene.

29. The invention according to claim 25, wherein the at least one microduct is comprised of high density polyethylene.

30. The invention according to claim 25, wherein the sheath is comprised of polyethylene.

31. The invention according to claim 25, further comprising applying a lubricous material to at least a portion of an external surface of the sheath.

32. The invention according to claim 25, wherein there are at least two microducts, wherein at least a portion of an external surface of the at least two microducts substantially abut at least a portion of an external surface of the at least one cable.

33. The invention according to claim 32, wherein the external surface of one of the at least two microducts substantially abuts the external surface of the other one of the at least two microducts.

34. The invention according to claim 32, wherein the external surface of one of the at least two microducts does not abut the external surface of the other one of the at least two microducts.

35. The invention according to claim 25, wherein there are a plurality of microducts, wherein at least a portion of an external surface of plurality of microducts substantially abut at least a portion of an external surface of the at least one cable.

36. The invention according to claim 35, wherein the external surface of one of the plurality of microducts substantially abuts the external surface of at least one other of the plurality of microducts.

37. A method of forming a conduit system, comprising:
providing at least one cable;
providing at least one microduct, wherein the at least one microduct is adapted to receive at least one other cable;
providing an elongated member;
bringing at least a portion of an external surface of the microduct and at least a portion of an external surface of the at least one cable into abutting engagement; and winding the member around at least a portion of the external surfaces of the at least one cable and the at least one microduct.

38. The invention according to claim 37, wherein the cable is selected from the group consisting of communications cable, power cable, and combinations thereof.

39. The invention according to claim 37, wherein the at least one microduct has a cross-sectional diameter in the range of about 5 to about 13 millimeters.

40. The invention according to claim 37, wherein the at least one microduct is comprised of polyethylene.

41. The invention according to claim 37, wherein the at least one microduct is comprised of high density polyethylene.

42. The invention according to claim 37, wherein the member is comprised of polyethylene.

43. The invention according to claim 37, further comprising applying a lubricous material to at least a portion of an external surface of the member.

44. The invention according to claim 37, wherein there are at least two microducts, wherein at least a portion of an external surface of the at least two microducts substantially abut at least a portion of an external surface of the at least one cable.

45. The invention according to claim 44, wherein the external surface of one of the at least two microducts substantially abuts the external surface of the other one of the at least two microducts.

46. The invention according to claim 44, wherein the external surface of one of the at least two microducts does not abut the external surface of the other one of the at least two microducts.

47. The invention according to claim 37, wherein there are a plurality of microducts, wherein at least a portion of an external surface of plurality of microducts substantially abut at least a portion of an external surface of the at least one cable.

48. The invention according to claim 47, wherein the external surface of one of the plurality of microducts substantially abuts the external surface of at least one other of the plurality of microducts.
